(19) United States
(12) Patent Application Publication
(10) Pub. No.: US 2009/0295966 A1
(43) Pub. Date: Dec. 3, 2009

(54) SOLID-STATE IMAGING DEVICE AND CAMERA

(76) Inventors: Hiroshi KUBO, Osaka (JP); Kunihiko Hara, Osaka (JP)

Correspondence Address: MCDERMOTT WILL & EMERY LLP, 600 13TH STREET, NW, WASHINGTON, DC, 20005-3096, US

(21) Appl. No.: 12/429,789

(22) Filed: Apr. 24, 2009

(30) Foreign Application Priority Data
May 30, 2008 (JP) 2008-142906

(51) Int. Cl. H04N 5/225

(52) U.S. Cl. 348/308; 348/E05.024

(57) ABSTRACT

A column amplifier includes: a load transistor having a gate for receiving a fixed potential; a drive unit configured to drive a current having a current value in accordance with a potential of the input point; a reset transistor configured to turn ON when the pixel signal is at a reset potential and turn OFF when the pixel signal is at a read potential; and a clip transistor configured to turn OFF when a potential of the output point is smaller than a predetermined potential and turn ON when the potential of the output point is the predetermined potential or greater, and the drive unit has a circuit structure configured to selectively apply first and second current driving abilities.

The disclosure of Japanese Patent Application No. 2008-142906 filed May 31, 2008 including specification, drawings and claims is incorporated herein by reference in its entirety.

### BACKGROUND OF THE INVENTION

(1) Field of the Invention

The present invention relates to a solid-state imaging device used for digital cameras and the like, and in particular to a technique to improve image quality.

(2) Description of the Related Art

In general, MOS (Metal Oxide Semiconductor)-type solid-state imaging devices employ a read method which reads pixel signals from an image array row by row, reading pixel signals from each row in parallel, temporarily retains the read pixel signals in column memories each provided for a column of the pixel array, and outputs the retained pixel signals from the column memories in serial. Also, according to many conventional examples, an amplifier (hereinafter, referred to as “column amplifier”) is provided on a vertical signal line of each column of the pixel array.

FIG. 1 is a circuit diagram showing a column amplifier of a solid-state imaging device according to Japanese Laid-Open Patent Application Publication No. H5-207220 (hereinafter, referred to as “Patent Document 1”), and FIG. 2 is a circuit diagram showing a column amplifier of a solid-state imaging device according to Japanese Laid-Open Patent Application Publication No. 2005-252529 (hereinafter, referred to as “Patent Document 2”).

A potential of a pixel signal Vpix is equal to a reset potential V1 when the pixel is in a reset period, and changes to a read potential V2 during a read period following the reset period. A reset transistor M53 of the column amplifier is turned ON during the reset period, and turned OFF during the read period. In the reset period, a potential Vout of an output point 56 of the column amplifier is fed back to an input point 55 via the reset transistor M53 and becomes equal to a potential Vamprst determined by a current driving ability of a drive transistor M52. In the read period, the potential Vout of the output point 56 of the column amplifier changes as the potential of the pixel signal Vpix changes, and becomes equal to Vamprst+(C1/C2)*(V2−V1). This means that a potential difference (V2−V1) that is equivalent to a light irradiation amount is amplified with a gain (C1/C2).

According to the structure of the column amplifier of Patent Document 2, a lower limit of an output potential of the column amplifier is the potential Vamprst determined by the current driving ability of the drive transistor M52, and an upper limit of the output potential is a potential (Vcut+Vthcut), i.e., a sum of a reference potential Vcut inputted to a gate of a clip transistor M54 and a threshold voltage Vthcut of the clip transistor M54. According to Patent Document 2, the reference potential Vcut is determined to be a potential within a range when a load transistor M51 operates in a saturation region. Also, the structure of the column amplifier according to Patent Document 1, the lower limit of the output potential of the column amplifier is the same as that of Patent Document 2, and the upper limit of the output potential of the column amplifier is a power supply potential. As is apparent from the above, according to the prior arts, the upper limit and the lower limit of the output potential (i.e. output range) are fixed.

Here, the particularity of a power supply layout of a solid- state imaging apparatus provided with column amplifiers is examined. FIG. 3 schematically shows a power supply layout, in a solid-state imaging device provided with column amplifiers, for driving the column amplifiers.

The column amplifiers 2 are each provided for a different one of columns of an image array 11, and naturally, disposed side-by-side in parallel. Power supply wiring 53 extends from a power supply pad 51 in the horizontal direction, and similarly, ground wiring 54 extends from a ground pad 52 in the horizontal direction. The column amplifiers are commonly connected to the power supply 53 and the ground wiring 54. Accordingly, if the power supply potential or the ground potential changes as a consumption current (load current flowing through the load transistor M51) of the column amplifier 2 of a given column changes, the power supply potential or the ground potential provided to the column amplifiers of columns in vicinities will also change. Especially, since the above-described power supply layout has high wiring resistance, a slight change in the load current will result in a large change in the potential. This being so, each column amplifier ends up outputting a potential that has been shifted from the appropriate output potential due to the change in the power supply potential and the like, causing image deterioration as a result.

### SUMMARY OF THE INVENTION

According to the structure of the column amplifier of Patent Document 1, the load current flowing through the load transistor M51 changes considerably when the output potential of the column amplifier changes due to brightness of incident light entering the pixel, and accordingly, image deterioration easily occurs. On the other hand, according to the structure of the column amplifier of Patent Document 2, because the load transistor M51 operates in the saturation region, a change in the output potential of the column amplifier causes little change in the load current. Yet, since a change in the load current is not completely suppressed, it is preferable that the output range of the column amplifier be set to the lowest possible range. Although the lowest possible range as the output range of the column amplifier changes according to an imaging condition and the like, the column amplifiers according to Patent Documents 1 and 2 are not able to change their output ranges as necessary.

The present invention aims to provide a technique which can arbitrarily change output ranges of column amplifiers provided in a solid-state imaging apparatus.

According to a first aspect of the present invention, there is provided a solid-state imaging device comprising: a pixel array having a plurality of pixels arranged in a matrix; and column amplifiers each provided for a different one of columns of the pixel array and configured to amplify a pixel signal from a pixel included in the different one of columns. Here, each column amplifier includes: an input point and an output point for the pixel signal; a load transistor that is inserted in a current path connecting power supply wiring and the output point and that has a gate for receiving a fixed potential; a drive unit that is inserted in a current path connecting the output point and ground wiring and that is configured to drive a current having a current value in accordance with a potential of the input point; a reset element that is inserted in a current path connecting the output point and the input point and that is configured to (i) turn ON when the pixel signal is at a reset potential and (ii) turn OFF when the pixel signal is at a read potential; and a limiting element that is inserted in a current path connecting the input point and the output point and that is configured to (i) turn OFF when a potential of the output point is smaller than a predetermined potential and (ii) turn ON when the potential of the output point is the predetermined potential or greater, and the drive unit has a circuit structure configured to selectively apply first and second current driving abilities, and selectively applies the first and second current driving abilities in accordance with a control signal inputted from outside the column amplifier.

According to a second aspect of the present invention, there is provided a camera comprising the above-mentioned solid-state imaging device and a control unit that is configured to select one of the first and second current driving abilities in accordance with an incident light amount entering the pixel array, and input, to the drive unit, a control signal identifying the selected one of the first and second current driving abilities.

The lower limit of the output potential of the column amplifiers are determined by the current driving ability of the drive unit when the reset element is ON. According to the above-stated structure, the lower limit of the output potential of the column amplifiers, and thus, the output range of the column amplifiers can be arbitrarily changed. Consequently, the output range of the column amplifiers can be set to a more appropriate range in accordance with an imaging condition and the like, compared with the conventional techniques, thereby achieving a reduction in image deterioration.

The drive unit may include first and second drive transistors and first and second switch elements, wherein the first drive transistor has a drain connected with the output point via the first switch element, a source connected with the ground wiring, and a gate connected with the input point, the second drive transistor has a drain connected with the output point via the second switch element, a source connected with the ground wiring, and a gate connected with the input point, when one of the first and second switch elements is ON, another of the first and second switch elements is OFF, and the first and second drive transistors have mutually different current driving abilities.

With the stated structure, the current driving abilities of the drive unit can be selectively applied.

The drive unit may include first and second drive transistors and first and second switch elements, wherein the first drive transistor has a drain connected with the output point, a source connected with the ground wiring, and a gate connected with the input point, the second drive transistor has a drain connected with the output point, a source connected with the ground wiring, and a gate connected with the input point via the first switch element and connected with the ground wiring via the second switch element, and when one of the first and second switch elements is ON, an other of the first and second switch elements is OFF.

With the stated structure, the current driving abilities of the drive unit can be selectively applied.

The limiting element may be a clip transistor having a gate for receiving a reference potential in accordance with the predetermined potential.

With the stated structure, the upper limit of the output range of each column amplifier can be arbitrarily changed by selectively applying the potential inputted to the gate of the clip transistor.

The clip transistor may have a well and a source connected with each other by wiring.

A threshold voltage of the clip transistor may be lower than a threshold voltage of any other transistors included in the column amplifier.

The lowest upper limit of the output range of each column amplifier is limited by the threshold voltage of the clip transistor. Because the above-stated structure minimizes the threshold voltage of the clip transistor, a lower limit of a target range for the upper limit of the output range of each column amplifier can be extended.

Each column amplifier may further include a capacitor that is inserted in the current path connecting the output point and the input point.

With the stated structure, a desired gain can be realized by arbitrarily setting the capacitance of the capacitor.

Each column amplifier may have a structure of a cascode amplifier circuit.

With the stated structure, the gain can be increased.

### BRIEF DESCRIPTION OF THE DRAWINGS

These and other objects, advantages and features of the invention will become apparent from the following description thereof taken in conjunction with the accompanying drawings which illustrate a specific embodiment of the invention. In the drawing:

FIG. 1 is a circuit diagram showing a column amplifier of a solid-state imaging device according to Japanese Laid-Open Patent Application Publication No. H5-207220;

FIG. 2 is a circuit diagram showing a column amplifier of a solid-state imaging device according to Japanese Laid-Open Patent Application Publication No. 2005-252529;

FIG. 3 schematically shows a power supply layout, in a solid-state imaging device provided with column amplifiers, for driving the column amplifiers;

FIG. 4 schematically shows a structure of a solid-state imaging device according to a first embodiment of the present invention;

FIG. 5 is a circuit diagram showing part of the solid- state imaging device according to the first embodiment;

FIG. 6 is a circuit diagram showing, as an example, part of a voltage generation circuit according to the first embodiment;

FIG. 7 is a circuit diagram showing, as an example, part of the voltage generation circuit according to the first embodiment;

FIG. 8 is a timing chart for explaining a read operation of a pixel signal according to the first embodiment;

FIG. 9 shows output ranges of column amplifiers;

FIG. 10 is a circuit diagram showing part of a solid-state imaging device according to a second embodiment of the present invention; and

FIG. 11 is a block diagram showing an imaging device according to a third embodiment of the present invention.

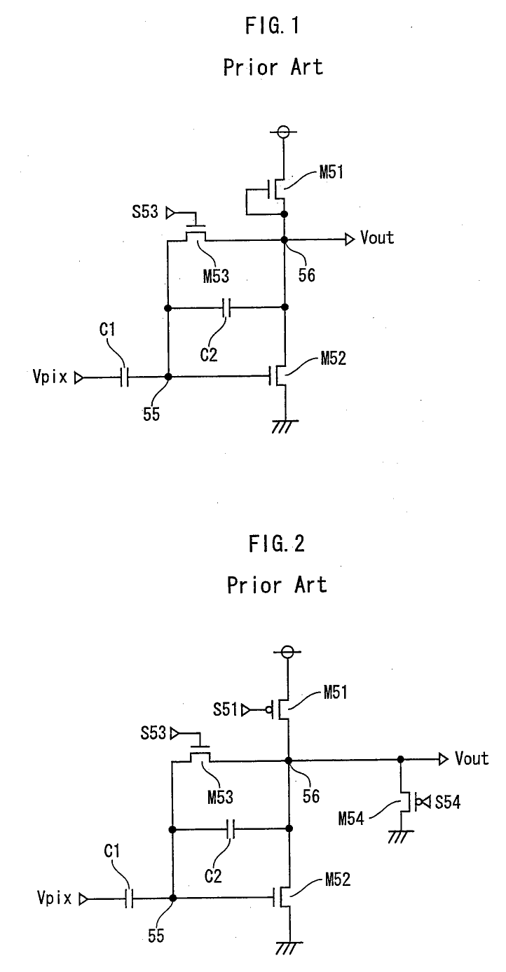

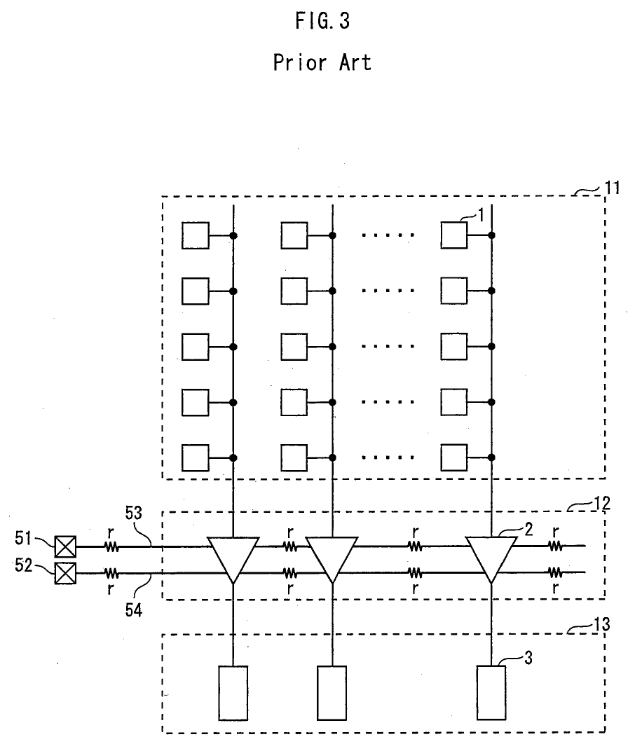

### DESCRIPTION OF THE PREFERRED EMBODIMENT

The following describes the best mode for carrying out the invention in detail with reference to drawings.

### First Embodiment

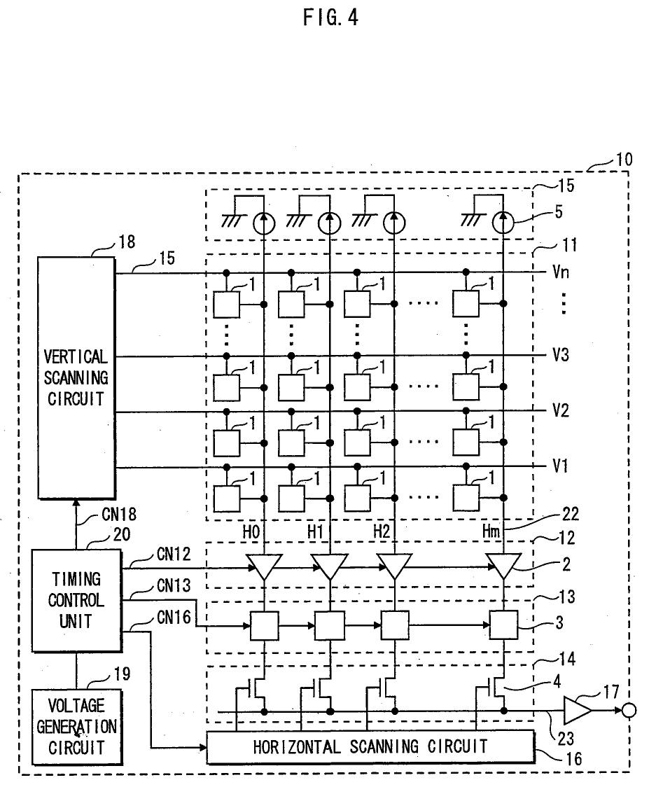

FIG. 4 schematically shows a structure of a solid-state imaging device according to a first embodiment of the present invention.

A solid-state imaging device includes the pixel array 11, column amplifiers 12, noise cancellation circuits 13, a multiplexer 14, load circuits 15, a horizontal scanning circuit 16, an output amplifier 17, a vertical scanning circuit 18, a voltage generation circuit 19, and a timing control unit 20.

The pixel array 11 includes a plurality of pixels 1 arranged in a matrix, and a column amplifier 2, a noise cancellation circuit 3, a switch element 4, and a load circuit 5 are provided for each column of the pixel array 11.

The pixels 1 included in the pixel array 11 are reset, charged, and read row by row, by operations of the vertical scanning circuit 18. Pixel signals read from each row of pixels are amplified by the column amplifiers 2 each provided for a different one of columns, and retained by the noise cancellation circuit 3 upon offset variation of the amplifiers being cancelled by the noise cancellation circuit 3. The pixel signals corresponding to one row of pixels retained by the noise cancellation circuit 3 are sequentially outputted via the multiplexer 14 and the output amplifier 17 by operations of the horizontal scanning circuit 16. The voltage generation circuit 19 generates various voltages necessary for circuits in the solid-state imaging device 10. The timing control unit 20 synchronizes and drives the circuits in the solid-state imaging device 10.

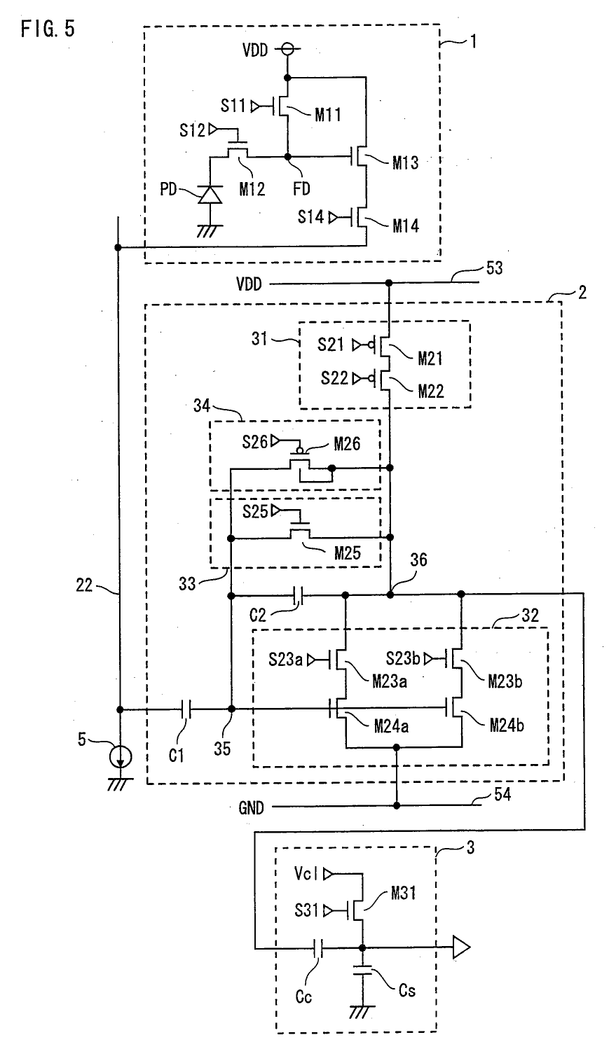

FIG. 5 is a circuit diagram showing part of the solid-state imaging device according to the first embodiment. Specifically, the figure shows a pixel 1, a column amplifier 2, and a noise cancellation circuit 3 in a given column.

The pixel 1 includes a photodiode (PD), a floating diffusion (FD), a reset transistor M11, a transfer transistor M12, a read transistor M13, and a selection transistor M14. The transfer transistor M12 is inserted in a current path connecting PD and FD. An ON/OFF state of the transfer transistor M12 is controlled by a charge transfer signal S12. The reset transistor M11 is inserted in a current path connecting a power supply and FD. An ON/OFF state of the reset transistor M11 is controlled by a pixel reset signal S11 inputted to a gate thereof. The read transistor M13 is inserted in a current path connecting the power supply and a drain of the selection transistor M14. A gate of the read transistor M13 is connected to FD. The selection transistor M14 is inserted in a current path connecting a source of the read transistor M13 and a vertical signal line 22. An ON/OFF state of the selection transistor M14 is controlled by a pixel selection signal S14.

The column amplifier 2 includes an input capacitor C1, a load unit 31, a drive unit 32, a reset unit 33, an output potential limiter 34, and a feedback capacitor C2. The input capacitor C1 is inserted in a current path connecting the vertical signal line 22 and an input point 35 and conveys a potential change of the vertical signal line to the drive unit 32. The load unit 31 includes a load transistor M21 and a cascode transistor M22, and functions as a load for a common source amplifier. The load transistor M21 has a gate for receiving a load bias potential S21, and the cascode transistor M22 has a gate for receiving a cascode bias potential S22. The drive unit 32 includes drive transistors M24a/M24b and switch transistors M23a/M23b, and functions as a drive unit of the common source amplifier. The drive transistor M24a has a drain connected to an output point 36 via the switch transistor M24a, a source connected to a grounding link 54, and a gate connected to the input point 35. The drive transistor M24b has a drain connected to the output point 36 via the switch transistor M23b, a source connected to the grounding link 54, and a gate connected to the input point 35. Here, the drive transistors M24a and M24b have mutually different current driving abilities. The different current driving abilities can be obtained by providing mutually different channel widths and channel lengths for the transistors. The switch transistor M23a has a gate for receiving a column amplifier drive selection signal S23a, and the switch transistor M23b has a gate for receiving a column amplifier drive selection signal S23b. The column amplifier drive selection signals S23a and S23b are related such that when one of them is at a high level, the other is at a low level. The reset unit 33 includes a reset transistor M25 having a gate for receiving a column amplifier reset signal S25. The output potential limiter 34 includes a clip transistor M26 having a gate for receiving a column amplifier clip signal S26. The feedback capacitance C2 is inserted in a current path connecting the input point 35 and the output point 36.

The noise cancellation circuit 3 includes a clamp capacitor Cc, a sample hold capacitor Cs, and a switch transistor M31.

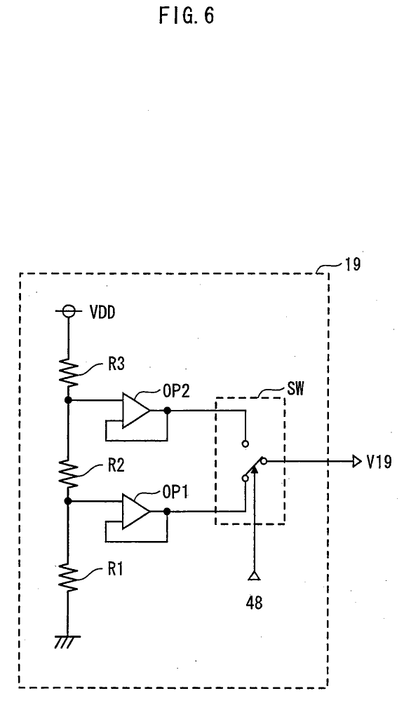

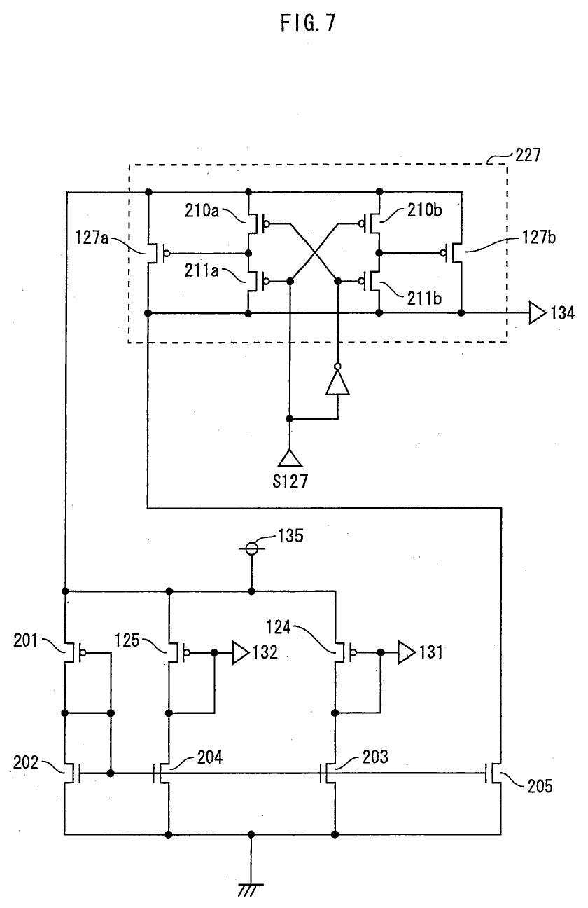

FIGS. 6 and 7 are circuit diagrams showing, as examples, part of the voltage generation circuit according to the first embodiment of the present invention. Specifically, these figures show a structure for generating a clip potential inputted to the gate of the clip transistor M26.

First, in the voltage generation circuit 19 in the example shown in FIG. 6, a power supply voltage is divided by resistors R1, R2, and R3, providing a potential Vcut1 at a connection point of the resistors R1 and R2, and a potential Vcut2 at a connection point of the resistors R2 and R3. The potentials Vcut1 and Vcut2 are inputted to a switch SW via voltage followers OP1 and OP2, respectively. The switch SW outputs one of the potentials Vcut1 and Vcut2 according to a column amplifier output potential upper limit control signal 48 inputted from outside the voltage generation circuit 19.

In the example shown in FIG. 7, the voltage generation circuit 19 copies, using a current-mirror structure, a current value determined according to a current source load transistor 201 and a current source mirror circuit transistor 202, thereby generating a bias voltage. A current flowing through the current source mirror circuit transistor 202 is copied to each bias source via a current source bias mirror circuit 203, a cascode bias mirror circuit 204, and a clip transistor bias mirror circuit 205. A current flowing through the current source bias mirror circuit 203 is inputted to a current source bias source 124, and a potential Vb is outputted from a current source bias terminal 131. A current flowing through the cascode bias mirror circuit 204 is inputted to a cascode bias source 125, and a potential Vcas is outputted from a cascode bias terminal 132. A current flowing through the clip transistor bias mirror circuit 205 is inputted to a clip transistor bias unit 227, and a potential Vcut is outputted from a clip transistor bias terminal 134. The clip transistor bias unit 227 is configured to switch between clip transistor bias sources 127a and 127b that have mutually different driving abilities, and is able to selectively generate a potential of Vcut1 and Vcut2.

The solid-state imaging device 10 shown in FIGS. 4-7 has the following features.

The drive unit 32 of each column amplifier 2 is able to selectively apply the drive transistors M24a and M24b, which have mutually different current driving abilities. Because a lower limit of an output range of each column amplifier 2 is determined by the current driving ability of the drive unit 32, the lower limit of the output range of each column amplifier 2 can be arbitrarily changed by selectively applying the drive transistors M24a and M24b.

One of the potentials Vcut1 and Vcut2 is selectively inputted to the gate of the clip transistor M26 of each column amplifier 2. An upper limit of the output range of each column amplifier 2 is determined by adding a threshold voltage Vthcut of the clip transistor M26 to the potential Vcut inputted to the gate of the clip transistor M26. The upper limit of the output range of each column amplifier 2 can be arbitrarily changed by selectively applying the potential inputted to the gate of the clip transistor M26.

Additionally, the threshold voltage Vthcut of the clip transistor M26 of each column amplifier 2 is set lower than a threshold voltage of any other transistors included in the column amplifier 2. Furthermore, the clip transistor M26 of each column amplifier 2 has a well and a source connected with each other. The lowest upper limit of the output range of each column amplifier 2 is limited by the threshold voltage of the clip transistor M26. Because the above-mentioned structure minimizes the threshold voltage of the clip transistor M26, a lower limit of a target range for the upper limit of the output range of each column amplifier 2 can be extended.

Next, a drive method for driving the solid-state imaging device according to the first embodiment of the present invention is described.

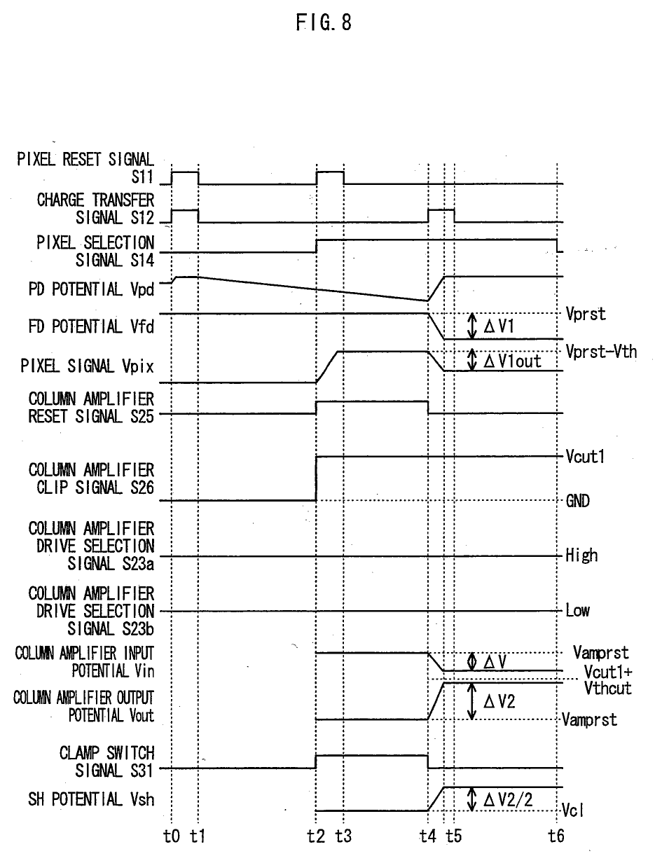

FIG. 8 is a timing chart for explaining a read operation of a pixel signal according to the first embodiment. First, at a timing t0, a potential of the pixel reset signal S11 is set to a high level, and a potential of FD is reset to Vprst, which is equal to (VDD−Vth). At the same time, a potential of the charge transfer signal S12 is set to a high level, and a charge remaining at PD is transferred to FD, whereby the charge accumulated at PD is reduced to zero. It should be noted here that the above-stated “same time” includes a case where (a) the timing at which the potential of the pixel reset signal S11 is set to the high level and the potential of FD is reset to Vprst and (b) the timing at which the potential of the charge transfer signal S12 is set to the high level and the charge remaining at PD is transferred to FD, whereby the charge accumulated at PD is reduced to zero completely coincide with each other, and in addition, includes a case where a time lag occurs between (a) and (b), the time lag being within a temporal range which allows the aim and the effects of the present invention to be achieved.

Next, at a timing t1, the potential of the pixel reset signal S11 and the potential of the charge transfer signal S12 are restored to a low level. This triggers charge accumulation at PD.

After that, at a timing t2, the potential of the pixel reset signal S11 is set to the high level, and the potential of FD is reset again to Vprst (=Vdd−Vth). At the same time, a potential of the pixel selection signal S14 is set to a high level, forming a source follower amplifier composed of the read transistor M13 and the load circuit 5. It should be noted here that the above-stated “same time” includes a case where (a) the potential of the pixel reset signal S11 is set to the high level and the potential of FD is reset again to Vprst (=Vdd−Vth) and (b) the timing at which the potential of the pixel selection signal S14 is set to the high level, forming the source follower amplifier composed of the read transistor M13 and the load circuit 5 completely coincide with each other, and in addition, includes a case where a time lag occurs between (a) and (b), the time lag being within a range which allows the aim and the effects of the present invention to be achieved. Especially, the timing at which the potential of S11 is set to the high level being delayed from the timing at which the potential of S14 is set to the high level by the time lag does not pose a problem. As a result, a potential equal to Vprst−Vth appears on the vertical signal line 22 (although the potential is equal to Vprst−Vth−α to be exact, a is omitted to simplify explanation). At the same time, the column amplifier reset signal S25 is set to a high level, and the potentials of the input point 35 and the potential of the output point 36 of the column amplifier are set to the reset potential Vamprst. It should be noted here that the above-stated “same time” includes a case where the timings completely coincide with each other, and in addition, includes a case where a time lag occurs between the timings, the time lag being within a range that allows the aim and the effects of the present invention to be achieved. Note that at this point, the column amplifier drive selection signal S23a is at the high level and the column amplifier drive selection signal S23b is at the low level. Accordingly, the reset potential Vamprst is determined according to the current driving ability of the drive transistor M24a. Also, a potential of the clamp switch signal S31 is set to a high level and a potential of the sample hold (SH) terminal is set to a clamp potential Vcl.

Next, at a timing 3, the potential of the pixel reset signal S11 is restored to the low level.

Next, at a timing t4, the column amplifier reset signal S25 is set to the low level to put the column amplifier 2 into a state of amplification operation. At the same time, the potential of the clamp switch signal S31 is set to a low level, putting the SH terminal into a floating state. It should be noted here that the above-stated “same time” includes a case where (a) the timing at which the column amplifier reset signal S25 is set to the low level to put the column amplifier 2 into the state of amplification operation and (b) the timing at which the potential of the clamp switch signal S31 is set to the low level, putting the SH terminal into the floating state completely coincide with each other, and in addition, includes a case where a time lag occurs between (a) and (b), the time lag being within a range which allows the aim and the effects of the present invention to be achieved. Especially, the timing at which the column amplifier reset signal S25 is set to the low level being delayed from the timing at which the potential of the clamp switch signal S31 is set to the low level by the time lag does not pose a problem. Additionally, the charge transfer signal S12 is set to the high level to transfer the charge accumulated at PD to FD. As a result, the potential of FD becomes Vprst−ΔV1, and the potential of the vertical signal line 22 falls to Vprst−Vth—ΔV1out. The value of ΔV1out is proportionate to the charge accumulated at PD. This potential fall causes the potential of the input point 35 to fall by ΔV, and the potential of the output point 36 to rise by ΔV2. The value ΔV2/ΔV1out is equal to a gain of the column amplifier 2. The rise of the potential of the output point 36 causes the potential of the SH terminal to rise from Vcl to Vcl+ΔV2/2 via the clamp capacitor Cc. Here, it is assumed that the capacitance of Cc and that of Cs are the same. The potential of the SH terminal is read out to outside the image array and is compared with Vcl, which is the output when the pixel is dark, to detect a difference of these two, thereby reading out the pixel signal.

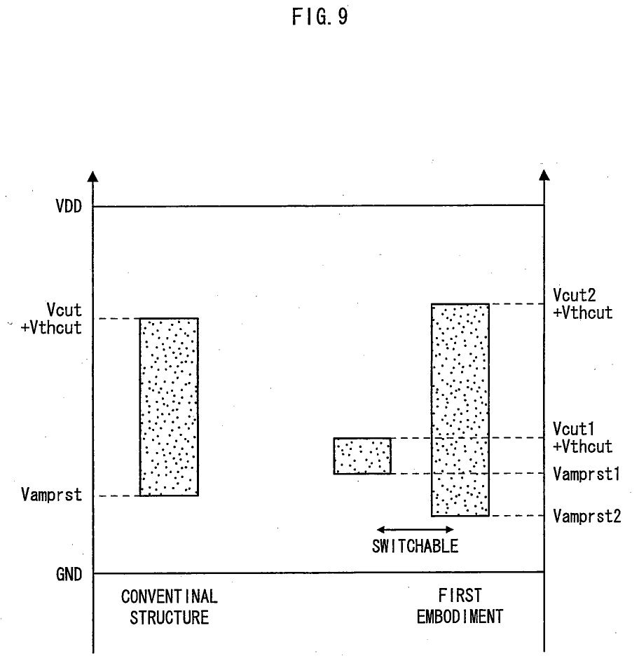

Additionally, a detailed description is given on the solid-state imaging device and the drive method according to the first embodiment, with reference to FIG. 9.

FIG. 9 shows output ranges of column amplifiers. The vertical axis indicates potential.

Because the black level varies as the load current of the column amplifier 2 varies, variation of the load current needs to be suppressed as much as possible. On the other hand, although the column amplifier 2 shown in FIG. 5 is an amplifier which performs constant current operations in general, the load current varies as the output potential varies, to be exact.

Accordingly, the upper limit of the output potential needs to be lowered to a necessary range, and the lower limit of the output potential needs to be raised to a necessary range. The upper limit of the output potential of the column amplifier is determined by the output potential limiter 34. It should be noted here that in the output potential limiter 34, when the output potential of the column amplifier is going to be equal to or greater than (the column amplifier clip potential Vcut)+(the threshold Vthcut of the clip transistor M26), the clip transistor M26 turns ON from OFF, increasing the potential of the input point 35 and decreasing the output potential of the column amplifier. Due to the above-described operation by the output potential limiter 34, the output potential of the column amplifier is limited to or below (Vcut+Vthcut).

According to the solid-state imaging device and the drive method therefor of the first embodiment of the present invention, the upper limit of the output range of each column amplifier is changed by switching the column amplifier clip potential between Vcut1 and Vcut2. Also, since the clip transistor M26 has the well and the source connected to each other, the threshold Vthcut does not rise because of a back gate bias effect, and accordingly, the upper limit of the output potential can be set lower than that set according to the conventional techniques. Furthermore, the upper limit of the output potential can be set even lower by setting the threshold voltage Vthcut itself of the clip transistor M26 low during a manufacturing process.

Additionally, according to the solid-state imaging device and the drive method therefor of the first embodiment of the present invention, selectively applying the drive transistors M24a and M24b enables the lower limit of the output potential of the column amplifier to be switched between Vamprst1 and Vamprst2. By switching the current driving ability like this, the case where a wide output range is required and the case where the lower limit of the output potential needs to be raised can be both satisfied. As a result, black level fluctuation due to variation of the load current of the column amplifier is reduced, thereby achieving a high-quality image. Also, being adjustable to a necessary range, the output range of the column amplifier can be adjusted in a manner that minimizes the black level fluctuation.

It should be noted that while the current driving ability of the drive unit 32 is switched between two levels according to the above-mentioned embodiment, it can be switched among three or more levels by connecting three or more drive transistors in parallel.

It should also be noted that while the current driving ability is switched by toggling according to the above-mentioned embodiment, it can be switched by switching a number of transistors used.

It should also be noted that while a capacitance ratio of the input capacitor to the feedback capacitor is constant according to the above-described embodiment, the capacitance ratio may be made switchable.

It should also be noted that while the voltage generation circuit is included in the solid-state imaging device according to the above-described embodiment, it can be provided outside the solid-state imaging device instead.

It should also be noted that the timing control unit is included in the solid-state imaging device, it can be provided outside the solid-state imaging device instead.

It should also be noted that while, according to the above-mentioned embodiment, (a) the clip transistor has the well and the source connected with each other, and (b) the threshold voltage of the clip transistor is manufactured to be lower than that of any other transistors, only one or neither of (A) and (B) may be performed.

It should also be noted that amplifier structures such as the following can be applied instead of the structure of the above-described column amplifiers: a cascode-type common source amplifier, a capacitance-feedback type amplifier; an inverter-type amplifier; a non-cascode-type common source amplifier; and a feedback-type amplifier.

### Second Embodiment

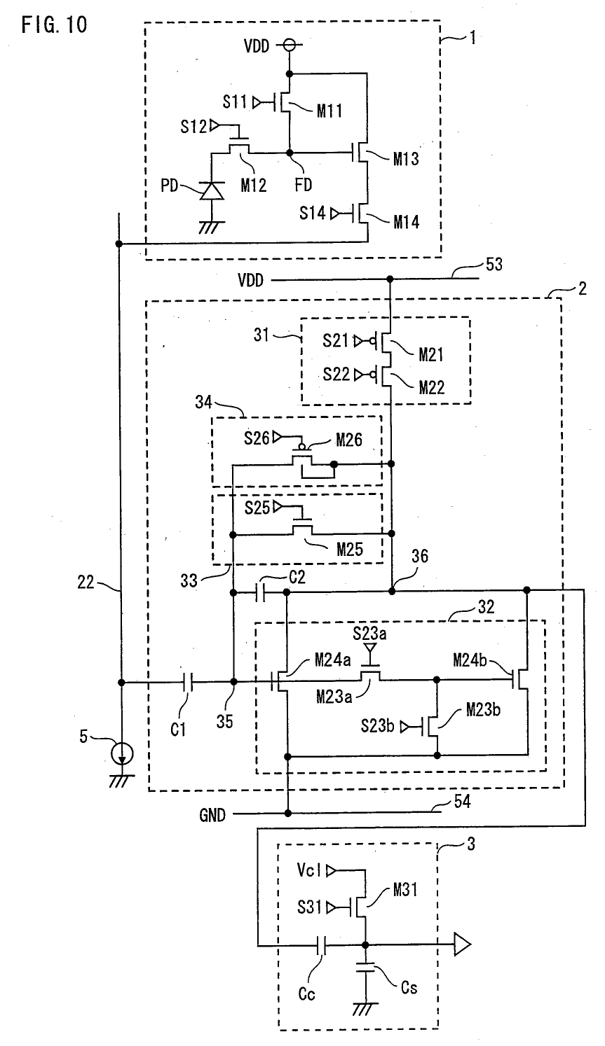

FIG. 10 is a circuit diagram showing part of a solid-state imaging device according to a second embodiment of the present invention. Specifically, a pixel 1, a column amplifier 2, and a noise cancellation circuit 3 of a given column are illustrated. The second embodiment differs from the first embodiment only in the structure of the drive unit 32.

The drive unit 32 includes the drive transistors M24a/M24b and the switch transistors M23a/M23b, and functions as the drive unit of the common source amplifier. The drive transistor M24a has the drain connected to the output point 36, the source connected to the grounding link 54, and the gate connected to the input point 35. The drive transistor M24b has the drain connected to the output point 36, the source connected to the grounding link 54, and the gate connected to the input point 35 via the switch transistor M23a and connected to the grounding link 54 via the switch transistor M23b. The switch transistor M23a has the gate for receiving the column amplifier drive selection signal S23a, and the switch transistor M23b has the gate for receiving the column amplifier drive selection signal S23b. The column amplifier drive selection signals S23a and S23b are related such that when one of them is at the high level, the other is at the low level.

The structure as stated above can achieve the same advantageous effects as the first embodiment.

It should be noted that while the current driving ability of the drive unit 32 is switched between two levels according to the above-described embodiment, it can be switched among three or more levels by connecting three or more drive transistors in parallel.

Also, the modifications described in the first embodiment may be applied to the second embodiment.

### Third Embodiment

A third embodiment of the present invention is an imaging device (camera, camera module) including the solid-state imaging device according to the first or the second embodiments.

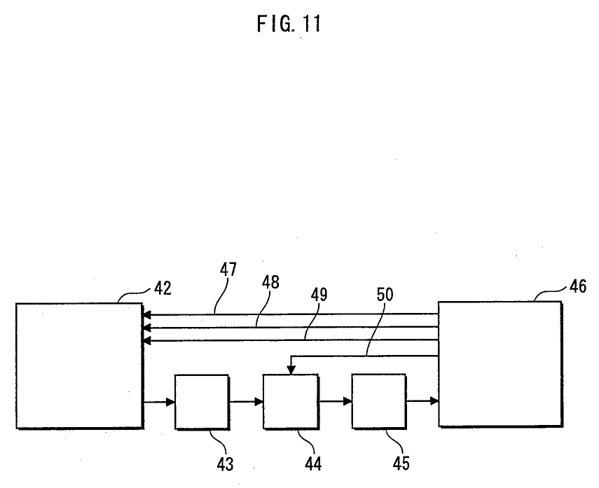

FIG. 11 is a block diagram showing the imaging device according to the third embodiment of the present invention.

Any of the solid-state imaging devices according to the first and second embodiments can be used as a solid-state imaging device 42. A pixel signal outputted from the solid-state imaging device 42 is inputted to a DSP (Digital Signal Processor) 46 via a noise cancellation circuit 43, a gain amplifier 44, and an ADC (Analog Digital Converter) 45. The DSP 46 performs image processing on the inputted pixel signal and controls the solid-state imaging device 42 to adjust an output range of the column amplifier, set a gain of the column amplifiers, and set a gain of the gain amplifier. Each column amplifier used in the solid-state imaging device 42 is a circuit shown in FIG. 5 or FIG. 10. The column amplifier output potential lower limit control signal 47 is inputted to the gate of the switch transistor M23b as the column amplifier drive selection signal S23a, and an inversion signal thereof is inputted to the gate of the switch transistor M23b as the column amplifier drive selection signal S23b. Also, the column amplifier output potential upper limit control signal 48 is inputted to the switch SW of the voltage generation circuit 19 (FIG. 6). The output range of each column amplifier of the solid-state imaging device 42 can be arbitrarily changed using the column amplifier output potential lower limit control signal 47 and the column amplifier output potential upper limit control signal 48.

It should be noted that the output range of each column amplifier of the solid-state imaging device 42 is controlled in conjunction with a column amplifier gain setting 49 and a gain amplifier gain setting 50. Specifically, when the gain setting are low, the output range of each column amplifier is set wide, and when the gain settings are high, the output range of each column amplifier is set narrow. When the gain settings are low, variation of the load current of the column amplifiers gives little influence on the image quality. Accordingly, it is effective to set the output range of each column amplifier wide and ensures a wider saturation amplitude. On the other hand, when the gain settings are high, setting the output range of each column amplifier narrow helps improve the image quality. As is apparent from the above, the present embodiment contributes to realization of a solid-state imaging device with high image quality.

It should be noted that while in FIG. 11, the solid-state imaging device is structured by combining discrete components, part or all of the blocks can be accumulated as an individual IC (Integrated Circuit). Also, although the gain amplifier shown FIG. 11 is described as an analogue element, amplification can be performed by post AD conversion digital processing.

Furthermore, according to the present embodiment, the output range of each column amplifier is controlled in conjunction with the gain settings. However, it can be controlled in accordance with other criteria. For example, a control may be performed such that the output range is set wide during a monitoring operation of a digital still camera, and the output range is set narrow in accordance with a required range when capturing an image for record.

Although the present invention has been fully described by way of examples with reference to the accompanying drawings, it is to be noted that various changes and modifications will be apparent to those skilled in the art. Therefore, unless otherwise such changes and modifications depart from the scope of the present invention, they should be construed as being included therein.

What is claimed is:

1. A solid-state imaging device comprising: a pixel array having a plurality of pixels arranged in a matrix; and column amplifiers each provided for a different one of columns of the pixel array and configured to amplify a pixel signal from a pixel included in the different one of columns, wherein
each column amplifier includes:
an input point and an output point for the pixel signal;
a load transistor that is inserted in a current path connecting power supply wiring and the output point and that has a gate for receiving a fixed potential;
a drive unit that is inserted in a current path connecting the output point and ground wiring and that is configured to drive a current having a current value in accordance with a potential of the input point;
a reset element that is inserted in a current path connecting the output point and the input point and that is configured to (i) turn ON when the pixel signal is at a reset potential and (ii) turn OFF when the pixel signal is at a read potential; and
a limiting element that is inserted in a current path connecting the input point and the output point and that is configured to (i) turn OFF when a potential of the output point is smaller than a predetermined potential and (ii) turn ON when the potential of the output point is the predetermined potential or greater, and
the drive unit has a circuit structure configured to selectively apply first and second current driving abilities, and selectively applies the first and second current driving abilities in accordance with a control signal inputted from outside the column amplifier.

2. The solid-state imaging device of claim 1, wherein
the drive unit includes first and second drive transistors and first and second switch elements, wherein
the first drive transistor has a drain connected with the output point via the first switch element, a source connected with the ground wiring, and a gate connected with the input point,
the second drive transistor has a drain connected with the output point via the second switch element, a source connected with the ground wiring, and a gate connected with the input point,
when one of the first and second switch elements is ON, an other of the first and second switch elements is OFF, and
the first and second drive transistors have mutually different current driving abilities.

3. The solid-state imaging device of claim 1, wherein
the drive unit includes first and second drive transistors and first and second switch elements, wherein
the first drive transistor has a drain connected with the output point, a source connected with the ground wiring, and a gate connected with the input point,
the second drive transistor has a drain connected with the output point, a source connected with the ground wiring, and a gate connected with the input point via the first switch element and connected with the ground wiring via the second switch element, and
when one of the first and second switch elements is ON, an other of the first and second switch elements is OFF.

4. The solid-state imaging device of claim 1, wherein
the limiting element is a clip transistor having a gate for receiving a reference potential in accordance with the predetermined potential.

5. The solid-state imaging device of claim 4, wherein
the clip transistor has a well and a source connected with each other by wiring.

6. The solid-state imaging device of claim 4, wherein
a threshold voltage of the clip transistor is lower than a threshold voltage of any other transistors included in the column amplifier.

7. The solid-state imaging device of claim 1, wherein
each column amplifier further includes a capacitor that is inserted in the current path connecting the output point and the input point.

8. The solid-state imaging device of claim 1, wherein
each column amplifier has a structure of a cascode amplifier circuit.

9. A camera comprising a solid-state imaging device and a control unit, wherein
the solid-state imaging device includes: a pixel array having a plurality of pixels arranged in a matrix; and column amplifiers each provided for a different one of columns of the pixel array and configured to amplify a pixel signal from a pixel included in the different one of columns, wherein
each column amplifier includes:
an input point and an output point for the pixel signal;
a load transistor that is inserted in a current path connecting power supply wiring and the output point and that has a gate for receiving a fixed potential;
a drive unit that is inserted in a current path connecting the output point and ground wiring and that is configured to drive a current having a current value in accordance with a potential of the input point;
a reset element that is inserted in a current path connecting the output point and the input point and that is configured to (i) turn ON when the pixel signal is at a reset potential and (ii) turn OFF when the pixel signal is at a read potential; and
a limiting element that is inserted in a current path connecting the input point and the output point and that is configured to (i) turn OFF when a potential of the output point is smaller than a predetermined potential and (ii) turn ON when the potential of the output point is the predetermined potential or greater,
the control unit is configured to select one of the first and second current driving abilities in accordance with an incident light amount entering the pixel array, and input, to the drive unit, a control signal identifying the selected one of the first and second current driving abilities, and
the drive unit has a circuit structure configured to selectively apply the first and second current driving abilities, and selectively applies the first and second current driving abilities in accordance with the control signal inputted from the control unit.
